(19) United States
(12) Patent Application Publication
(10) Pub. No.: US 2008/0245840 A1
(43) Pub. Date: Oct. 9, 2008

(54) Pneumatic nailer

(75) Inventors: Jonathan Beauclair, Louiseville (CA); Andre Deziel, St-Mathieu du Parc (CA)

Correspondence Address: LESPERANCE & MARTINEAU, 1440 WEST, STE-CATHERINE ROOM 700, MONTREAL, QC, H3G1R8, CA

(73) Assignee: CRESSWELL INDUSTRIES INC., Shawinigan (CA)

(21) Appl. No.: 11/783,121

(22) Filed: Apr. 6, 2007

(51) Int. Cl. B25C 7/00

(52) U.S. Cl. 227/148

(57) ABSTRACT

A pneumatic nailer comprising a frame defining a fastener ejection opening, and an elongated driver chamber. The driver chamber in turn defines a peripheral wall, a first end away from the fastener ejection opening and a second end towards the fastener ejection opening. The nailer also comprises trigger member and a piston member movable between a first position and a second position. The piston member comprises a piston driver slidably mounted in the driver chamber. When the piston member is moved towards the first position, the piston driver is moved towards the driver chamber first end; when the piston member is moved towards the second position, the piston driver is moved towards the driver chamber second end. The piston driver subdivides the driver chamber in two subchambers, namely (1) a first subchamber on one side of the piston driver, and comprising a fluid inlet for selectively admitting compressed air in the first subchamber in order to increase the pressure therein and urge the piston member towards said driver chamber second end, and (2) a second subchamber on another side of the piston driver, the second subchamber for fluid communication with the atmosphere through the fastener ejection channel. The piston member also comprises a striking member carried by the piston driver and engaging the fastener ejection opening at least when the piston member is in the second position. The piston member also comprises a selectively open exhaust passage allowing fluid communication between the first subchamber and the second subchamber, the exhaust passage being open at least when the piston member is in the striking position. When the piston member moves from the second position to the first position, air flows from the first subchamber towards the second subchamber through the exhaust passage, and from the second subchamber outwardly into the atmosphere through the fastener ejection opening.

### FIELD OF THE INVENTION

The present invention relates to nailers, and more particularly to pneumatic, impact-triggered nailers for hardwood flooring.

### BACKGROUND OF THE INVENTION

Hardwood flooring generally consists of a number of elongated narrow tongue-and-groove planks interlocked with each other and then fastened in position to a subjacent subfloor. To fasten these hardwood planks to the subfloor of a room, which is made of plywood plates or floor joists for example, it is known to use pneumatic nailers. Such nailers generally comprise a frame having a handle and a floor-engageable shoe for engaging a hardwood plank underneath the nailer. The nailer frame defines a number of pneumatic chambers therein, and a fastener ejection channel in the form of an elongated groove. These nailers also comprise a magazine holding a number of fasteners (brads, staples, etc.), and serially loading them into the fastener ejection channel.

A fastener discharge mechanism is also provided on these nailers. These fastener discharge mechanisms generally comprise a cylinder in line with the fastener ejection channel. A piston assembly is slidably mounted in the cylinder. The piston assembly comprises a disc-shaped piston head engaging the inner wall of the cylinder in an air-tight and slidable fashion, and an impact rod carried by the piston head. The impact rod engages the fastener ejection channel; upon triggering of the nailer, the impact rod forcibly sweeps the fastener ejection channel, strikes any fastener loaded therein and drives it into the subjacent hardwood plank.

At rest, the piston head is moved away from the fastener ejection channel, and the impact rod is completely retracted inside the cylinder. When the nailer is triggered, a two-stroke discharge cycle is initiated:
1. Firstly, a nailing stroke is triggered wherein compressed air is admitted in the cylinder above the piston head thus generating a substantial air pressure differential between both sides of the piston head. This air pressure differential causes the piston to be briskly urged outwardly of the cylinder, and the impact rod to forcibly sweep the discharge channel and strike the fastener therein.
2. The return stroke of the piston assembly follows, wherein the piston returns to its initial, retracted position in order to be able to initiate a subsequent nailing cycle.

Generally as the piston returns to its initial, retracted position, a vacuum is created in the cylinder chamber beneath the piston head, and as a result, ambient air is sucked in the cylinder through the fastener ejection channel. Since a hardwood floor in the making generally comprises substantial amounts of wood dust, each return stroke of the piston causes small amounts of wood dust to be sucked inside the nailer. The wood dust sucked in the nailer binds to the oil and lubricants of the nailer's internal components, and gums up the fastener discharge mechanism. The nailer has to be frequently opened up, disassembled and thoroughly cleaned and re-lubricated, which can be a tedious and time-consuming task.

### SUMMARY OF THE INVENTION

The present invention relates to a pneumatic nailer for driving nails into a workpiece, said nailer comprising:
a frame defining a fastener ejection opening, and an elongated driver chamber, said driver chamber in turn defining a peripheral wall, a first end away from said fastener ejection opening and a second end towards said fastener ejection opening;
a selectively activated trigger member mounted to said frame;
a piston member movable between a first position and a second position, comprising at least:
   a piston driver slidably engaging said driver chamber peripheral wall and movable along said driver chamber, wherein when said piston member is moved towards said first position, said piston driver is moved towards said driver chamber first end, and wherein when said piston member is moved towards said second position, said piston driver is moved towards said driver chamber second end, said piston driver subdividing said driver chamber in two subchambers, namely:
      a first subchamber on one side of said piston driver, and comprising a fluid inlet for selectively admitting compressed air in said first subchamber in order to increase the pressure therein and urge said piston driver towards said driver chamber second end;
      a second subchamber on another side of said piston driver, said second subchamber for fluid communication with the atmosphere through said fastener ejection channel;
   a striking member carried by said piston driver, said striking member engaging said fastener ejection opening at least when said piston member is in said second position;
at least one selectively opened fluid exhaust passage allowing fluid communication between said first subchamber and said second subchamber, said exhaust passage being open at least when said piston member is in said striking position;
wherein when said piston member moves from said second position to said first position, air flows from said first subchamber towards said second subchamber through said exhaust passage, and from said second subchamber outwardly into the atmosphere through said fastener ejection opening.

In one embodiment, said fluid exhaust passage is provided on said piston member.

In one embodiment, the pneumatic nailer further comprises return means capable of moving said piston driver back towards said first position after it has been moved into said second position.

In one embodiment, said return means include a return surface of said piston member, said return surface for exposure to compressed air within said nailer frame, the pressure from compressed air applied on said return surface biasing the piston member towards its said first position.

In one embodiment, said exhaust passage defines a first end and a second end, said exhaust passage second end opening into said second subchamber, and said exhaust passage first end is sealed at least when said piston member is in said first position, and said exhaust passage first end is unsealed and said exhaust passage is open at least when said piston member is in said second position.

In one embodiment:
said frame defines a hollow housing, which in turn defines a reservoir chamber and said driver chamber, said reservoir chamber and said driver chamber being separated by a partition having a selectively sealed partition opening therein;
said reservoir chamber is pressurized during operation of said nailer;
when said partition opening is unsealed, said reservoir chamber and said first subchamber fluidly communicate with one another therethrough; and
upon activation of said trigger member, said partition opening is opened and said first subchamber becomes pressurized.

In one embodiment, said trigger member comprises a poppet valve movable within said housing and defining a sealing portion, said poppet valve movable between a closed limit position in which said sealing portion seals said partition opening, and an open position where said sealing portion clears said partition opening.

In one embodiment:
said poppet valve is hollow and defines an elongated poppet chamber therein, and said poppet valve has a piston opening in said sealing portion which opens into said poppet chamber, said piston opening defining a peripheral wall;
said piston member further comprises an elongated piston stem attached to and moving as one with said piston driver, said piston stem at least partially penetrating in said poppet chamber through said piston opening, said piston stem sealingly yet slidably engaging said piston opening peripheral wall;
said exhaust passage first end is made in said piston stem; and
at least when said piston member is in said first position, said exhaust passage first end is substantially sealed by said piston opening peripheral wall, and at least when said piston member is in said second position, said exhaust passage first end is cleared by said piston opening peripheral wall.

In one embodiment:
said piston stem comprises an elongated main portion slidably engaging said peripheral wall of said poppet valve piston opening, said main portion connected to a piston stem base at one end and carrying a plunger at another end, said piston stem base secured to said piston driver and carrying said striking member, said piston stem base wider than said piston stem main portion; and
an outer peripheral wall of said plunger slidably yet sealingly engages a peripheral wall of said poppet chamber.

In one embodiment:
said poppet chamber is elongated and defines a first and a second end;
a pushback chamber is defined in said poppet chamber and is delimited by said piston stem main portion, said poppet chamber peripheral wall, and said plunger, said pushback chamber permanently communicating with said reservoir chamber through at least one orifice made through said poppet chamber peripheral wall;
said plunger defines a pushback surface exposed to said pushback chamber, said pushback surface forming said return means; and
compressed air pressure applied on said plunger pushback surface constantly biases said piston driver towards said first position.

In one embodiment:
said exhaust passage first end is located on said piston stem main portion;
said piston member reaches its said first position when said piston stem base strikes a bottom surface of said poppet valve;
said exhaust passage first end becomes sealed by said piston opening peripheral wall before said piston member reaches its said first position, and air trapped in said first subchamber acts as an air cushion to dampen the movement of said piston member towards its said first position.

In one embodiment:
said trigger member further comprises an anvil member projecting outwardly of said nailer frame, said anvil member coupled to and moving as one with said poppet valve;
anvil member can be struck in order to urge said trigger member into its said open position.

In one embodiment:
said trigger member further comprises an anvil member projecting outwardly of said nailer frame, said anvil member coupled to and moving as one with said poppet valve;
said anvil member can be struck in order to urge said trigger member into its said open position.

The present invention also relates to a pneumatic nailer for driving fasteners under pressurized air bias into a workpiece, said nailer having pressurized air chamber means including a number of subchambers in fluid communication with one another via channel means, said subchambers including an open fastener outlet subchamber, a cyclical fastener discharge means in fluid communication with said air chamber means for forcible release of fasteners one at a time outwardly from said nailer through said fastener outlet subchamber, a trigger member for selectively activating said fastener discharge means for cyclical fastener release one at a time, wherein said air chamber means includes control means controlling fluid flow through said channel means in such a way as to prevent development of negative air pressure about said fastener outlet subchamber during a full cycle of said cyclical fastener discharge means.

Preferably, said cyclical discharge means includes a first fastener discharge step and a second return step where said fastener discharge means returns back to a standby condition activatable by said trigger member, and said fastener outlet subchamber remains constantly at a positive air pressure during said return step of said fastener discharge means.

### DESCRIPTION OF THE DRAWINGS

In the annexed drawings:

FIG. 1 is a perspective view of a nailer positioned on the corner of a hardwood tongue-and-groove type plank, and further showing a mallet about to strike the anvil member of the nailer;

FIG. 2 is a side, partly broken enlarged view of the bottom portion of the nailer, as the latter drives a fastener into a hardwood plank and the subjacent subfloor;

FIGS. 3-8 are longitudinal, sectional elevations of the housing of the nailer's fastener discharge mechanism, and sequentially showing the movement of the internal components of the nailer during a nailing cycle. Only FIG. 3 is thoroughly numbered for clarity purposes;

FIG. 9 is an exploded perspective view of the piston assembly of the nailer; and

FIG. 10 is a bottom plan view of the housing.

### DETAILED DESCRIPTION OF THE EMBODIMENTS

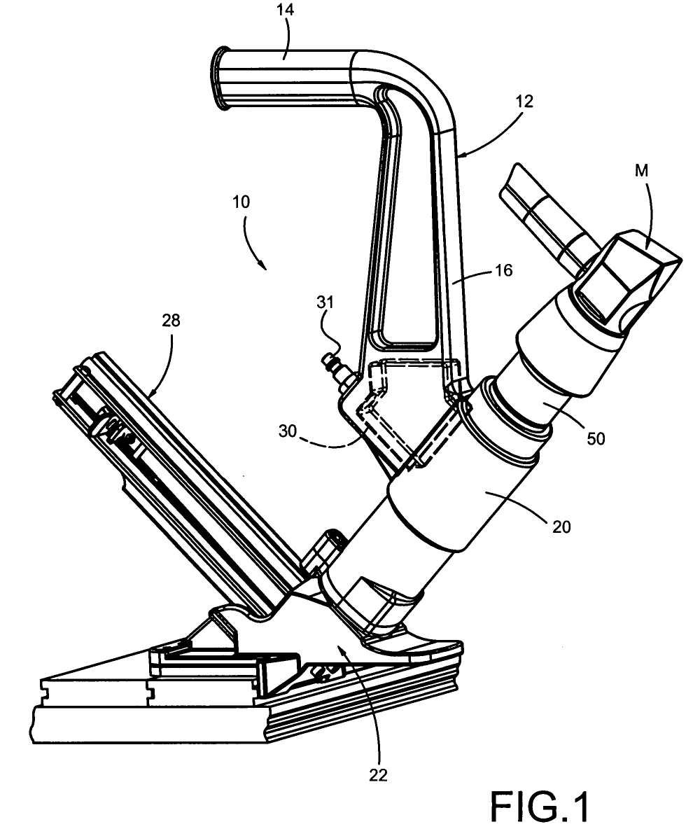

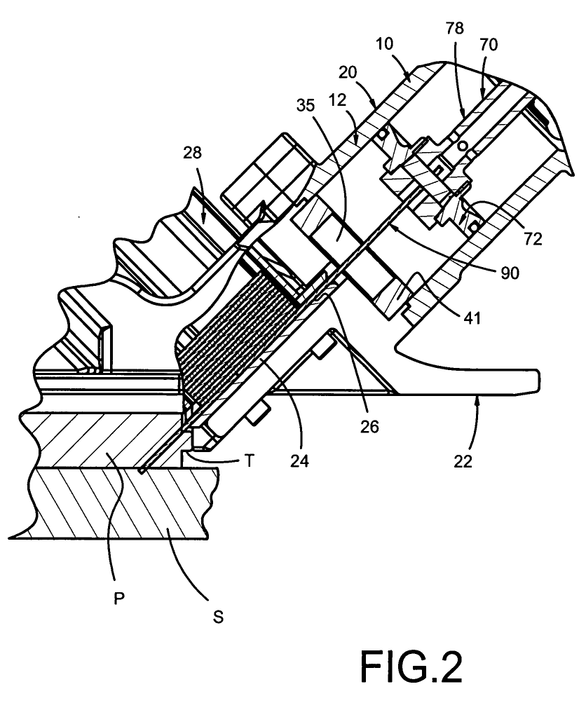

FIG. 1 shows a pneumatic nailer 10 according to the present invention. Nailer 10 comprises a frame 12, made of cast aluminium for example. Frame 12 has a handle 14 merging with an arm portion 16, which in turn merges with a mechanism housing 20. As further illustrated in FIG. 2, a conventional fastener ejection plate 24 is bolted to shoe 22, and defines an elongated groove therein which forms a fastener ejection opening or channel 26 of the tool. A magazine 28, releasably attached to shoe 22, holds a series of fasteners (e.g. a strip of brads or staples), and loads them serially into fastener ejection channel 26.

Furthermore, a shoe 22 is attached (by bolting for example) to housing 20. Shoe 22 serves as a guide for nailer 10, and ensures proper alignment of the tool on the corner of an underlying workpiece (e.g. a hardwood tongue-and-groove type plank). It will more particularly ensure that a nail discharged out of nailer 10 be driven into the subjacent hardwood plank at the proper angle, and at the appropriate location, i.e. at the base of tongue T of plank P (see FIG. 2).

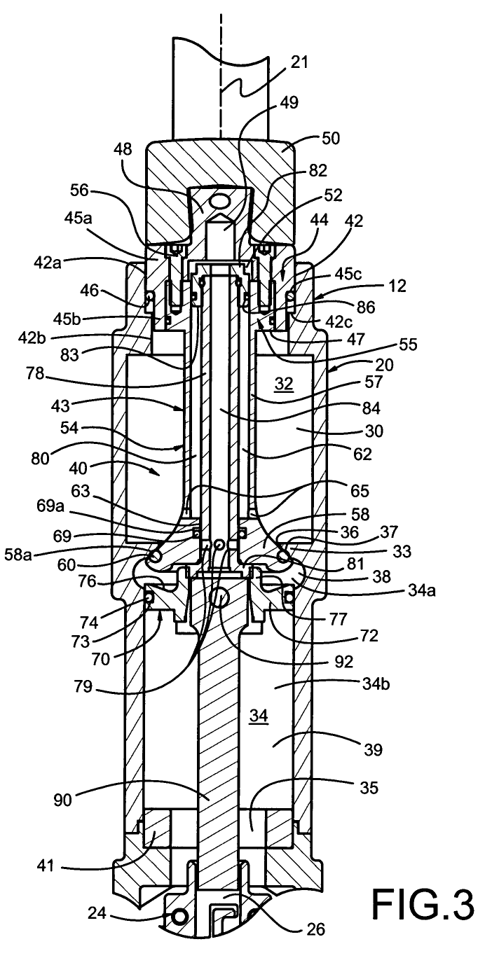

Frame 12 is provided with a main compressed air chamber 30 extending partially into frame arm portion 16 (see FIG. 1), and extending into the upper portion of housing 20 (see FIGS. 3-8), which is called reservoir chamber 32 hereafter. A compressed air input 31 (see FIG. 1), in the form of a conventional hose connector, is provided on frame 12, and opens into the portion of main chamber 30 extending into the frame arm portion 16. Prior to using the nailer, one end of a flexible hose (not shown) must be connected at one end to a compressed air source (e.g. an air compressor), and at the other end to air input 31.

Housing 20, best shown in FIGS. 3-8, is elongated and defines a housing axis 21, and encloses a pneumatic fastener discharge mechanism 40 comprising a number of movable components. This fastener discharge mechanism 40 can be triggered as described hereafter to strike a fastener loaded in fastener ejection channel 26 by magazine 28.

More particularly, housing 20 comprises a circular opening 42 made at its top extremity. Opening 42 is two-tiered and comprises an outer section 42a and inner section having a smaller diameter than outer section 42b. A shoulder 42c is defined at the junction between inner and outer section 42a, 42b.

Opening 42 opens into reservoir chamber 32. Reservoir chamber 32 is separated from a driver chamber 34 by a housing partition 33, which is provided with a central opening 36 made therethrough. Opening 36 is peripherally bevelled at 37 (bevel 37 widens gradually from reservoir chamber 32 towards driver chamber 34), and bevel 37 can be peripherally sealingly engaged by the conical end 58 of a poppet valve 54, as described hereinafter. Driver chamber 34 defines two portions, a toroidal section 38 and a cylindrical, diametrically smaller elongated cylindrical section 39. The bottom end of driver chamber 34 (opposite partition 33) is open at 35, and registers above fastener ejection channel 26 of nailer 10. An annular shock absorber 41, made of rubber for example, is installed at the bottom of driver chamber 34, circumscribing opening 35.

A trigger member 43 is movably installed in the upper portion of housing 20.

Trigger member 43 comprises a metallic anvil member 44 movably mounted in opening 42. Similarly to opening 42, the outer wall of anvil member 44 is of variable diameter and defines an upper section 45a engaging the upper section 42a of opening 42, and a lower section 45b diametrically smaller than upper section 42a and engaging opening lower section 42a. A shoulder 45c is defined at the junction between the upper and lower sections 45a, 45b; a sealing member in the form of an O-ring 46 (FIG. 3) rests against shoulder 46. O-ring 46 ensures that the interstice between anvil member 44 and the peripheral wall of opening 42 be substantially airtight at all times, so that compressed air from reservoir chamber 32 be prevented from seeping therethrough.

As can be seen in FIGS. 3-8, a stub 48 extends from the top surface of anvil member 44 away from housing 20 along axis 21. Stub 48 is bored at 49, and a rubber bumper cap 50 is friction fitted around stub 48. Finally, anvil member 44 is partially hollow and defines a cavity 52.

Trigger member 43 further comprises a poppet valve 54 coupled to anvil member 44. A T-shaped top end portion 55 of poppet valve 54 is received in anvil member cavity 52, and is bolted to anvil member 44 using bolts 56 for example.

Trigger member 43—i.e. the assembly of poppet valve 54 and anvil member 44—defines a return surface 47 constantly exposed to reservoir chamber 32.

Poppet valve 54 is a hollow, elongated member, extending along axis 21. Poppet valve top end portion 55 merges with a cylindrical shaft portion 57, which in turn merges with a flared conical end 58, also called the poppet valve sealing portion hereafter. Conical end 58 defines a peripheral groove 58a of truncated circular shape, into which is snap-fitted a rubber O-ring 60. Conical end 58 extends partially into reservoir chamber 32, and also partially through housing partition 33 into driver chamber 34.

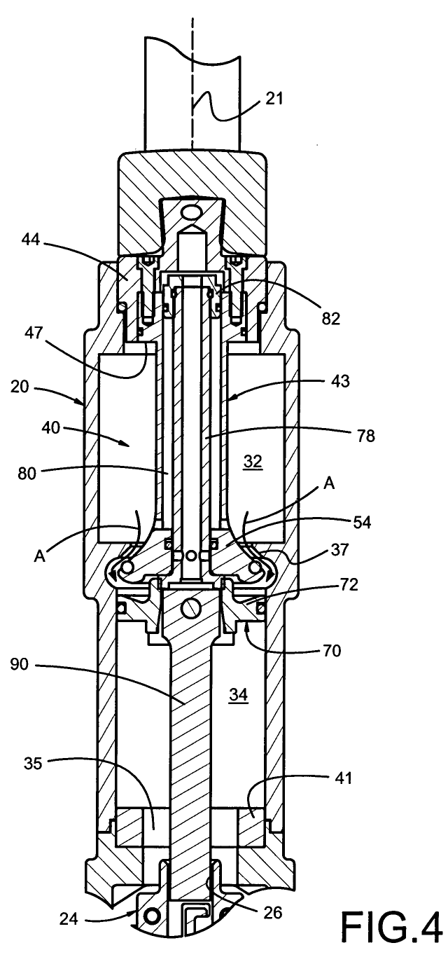

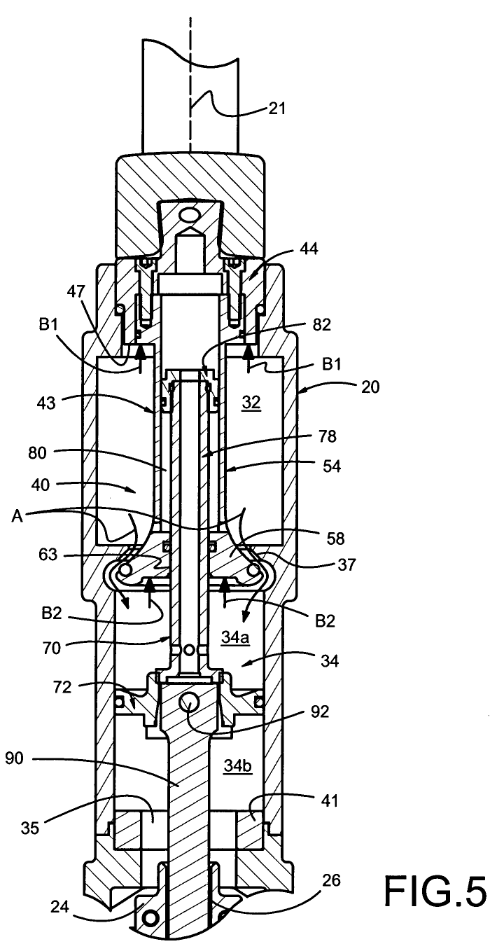

As can be seen in FIG. 4, trigger member 43 is movable within housing 20 along axis 21. More particularly, trigger member 43 can move between two limit positions:
a rest limit position as shown in FIG. 3, 6 and 7, where:
   trigger member 43 is moved upwardly;
   poppet valve conical end 58, and more particularly the O-ring 60 provided therearound, sealingly engages the bevelled edge 37 of partition opening 36. Opening 36 is thus sealed and compressed air is prevented from flowing from reservoir chamber 32 towards driver chamber 34 therethrough; and
   anvil member shoulder 45c is moved away from housing opening shoulder 42c.
an open limit position as shown in FIGS. 4 and 5, where:
   trigger member 43 is moved downwardly;
   poppet valve conical end 58 clears the bevelled edge 37 of partition opening 36. In this position of trigger member 43, compressed air is allowed to flow from reservoir chamber 32 towards driver chamber 34 through opening 36;
   anvil member shoulder 45c is moved towards housing opening shoulder 42c, and O-ring 46 is compressed therebetween.

Poppet valve 54 is hollow as mentioned above, and comprises a cylindrical poppet chamber 62. Poppet chamber 62 extends along shaft portion 57, and through the top end 55 of poppet valve 54. Cylindrical poppet chamber 62 merges with a coaxial piston opening 63 extending across the poppet valve conical end 58. The peripheral wall of piston opening 63 defines a cross-sectional square peripheral groove 69a, which accommodates an O-ring 69. Moreover, poppet chamber 62 can communicate with reservoir chamber 32 through radial orifices 65 made in poppet valve shaft portion 57.

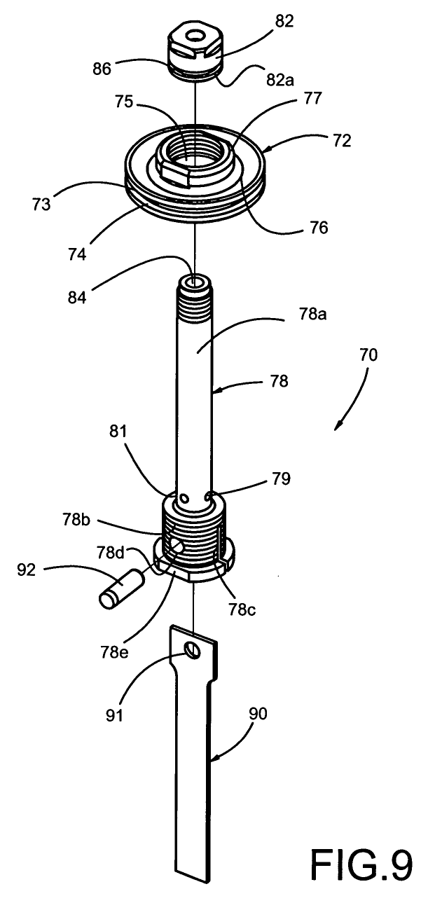

Fastener discharge mechanism 40 is further provided with a piston assembly 70 (best seen in FIG. 9). Piston assembly 70 comprises a discoid piston driver 72 slidably engaging the peripheral wall of the cylindrical section 39 of driver chamber 34. A cross-sectionally square groove 73 is made peripherally around piston driver 72, and contains an O-ring 74. Groove 73 also contains conventional lubricant (not shown) permitting smooth sliding motion of the piston driver 72 along driver chamber section 39.

Piston driver 72 comprises a central opening 75, and an annular rim 77 therearound projecting upwardly from the top surface of driver 72. An annular groove 76 is made in the top surface of piston driver 72 around annular rim 77.

Piston assembly 70 also comprises a tubular piston stem 78 attached centrally to piston driver 72. The lumen of tubular piston stem 78 forms an inner piston chamber 84. Piston stem 78 defines an elongated main portion 78a, and a diametrically larger base portion 78b having a threaded outer surface and defining a pair of diametrically opposite radial slots 78b (only one slot 78b shown in FIG. 9). Base portion 78b also comprises a pair of diametrically opposite holes 78d (only one hole 78d shown in FIG. 9). An annular flange 78e extends radially away from the free end of base portion 78b, transversally thereto.

A shoulder 81 is defined at the junction between piston stem main portion 78a and base portion 78b. A number of radial orifices 79 are made in piston stem main portion 78a, and are slightly spaced away from the piston stem shoulder 81.

A plunger 82 is screwed to the threaded end 78b of piston stem main portion 78a opposite base 78b. Plunger 82 is centrally pierced, and registers with piston chamber 84. A cross-sectionally square annular groove 82a is made inwardly and circumferentially in the outer surface of plunger 82, and accommodates an O-ring 86.

Finally, piston assembly 70 is provided with a striking member in the form of an impact rod 90. The top end of impact rod 90—pierced at 91—is coupled to piston stem base 78b. More particularly, the top-end of impact rod 90 is slipped between both slots 79c on the sides of piston stem base 78b, and is fastened thereto by inserting a pin 92 through holes 78d in piston stem base 78b, and through opening 91 in impact rod 90.

As mentioned above, piston stem 78 is attached to piston driver 72. More particularly, the threaded outer surface of base portion 78b is screwed to the threaded inner wall of piston driver annular rim 77, until piston stem annular flange 78e is pressed against the bottom surface of piston driver 72. The engagement of piston stem base 78b with piston driver annular rim 77 completely obstructs holes 78d in stem base 78b, and thus prevents disengagement of pin 92 from piston stem base 78b, and thus disengagement of impact rod 90 from piston stem 78.

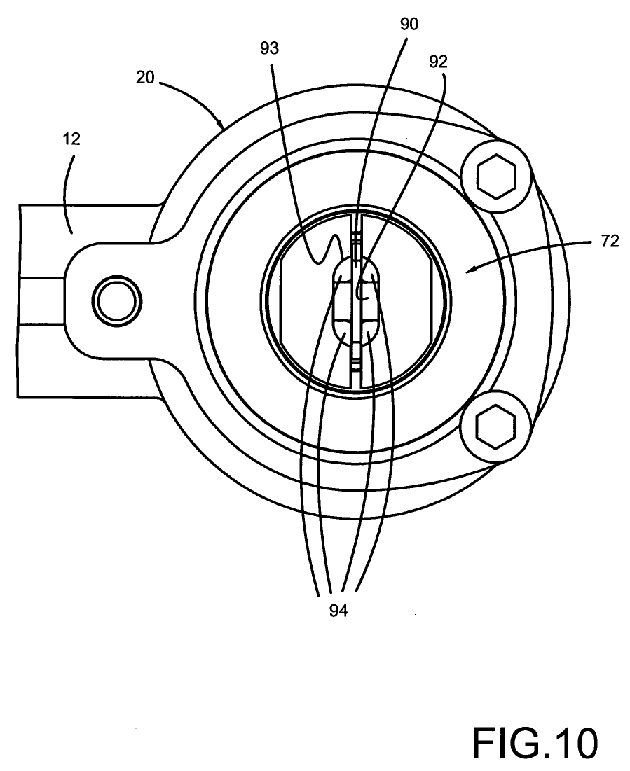

In the above-described piston assembly 70, a number of gaps 94 (FIG. 10) are defined between the inner wall of piston stem base 78b, impact rod 90 and its attachment pin 92. These gaps 94 allow permanent and uninterrupted fluid communication between piston chamber 84 and the volume of air located below piston driver 72, as described hereafter.

The piston assembly 70—formed of the assembly of piston driver 72, piston stem 78, plunger 82 and impact rod 90—moves as one within housing 20, as will now be described.

The piston driver 72 is movably received in driver chamber 34: it can slide back and forth along the peripheral wall of driver chamber 34, and more particularly along its cylindrical section 39. Moreover, piston stem main portion 78a extends upwardly from piston driver 72 and penetrates into poppet chamber 62 through piston opening 63 made in poppet conical end 58. The outer diameter of piston stem main portion 78a is substantially equal to that of the piston opening 63. The outer wall of piston stem main portion 72a engages, in an airtight yet sliding fashion, the O-ring 69 recessed in the peripheral wall of piston opening 63.

Plunger 82, secured to the top end of piston stem main portion 78a, is slidable within poppet chamber 62. More particularly, the peripheral wall of plunger 82 has a diameter substantially equal to that of the peripheral wall of poppet chamber 62, and O-ring 86 around plunger 82 engages the peripheral wall of poppet chamber 62 in an airtight and sliding fashion.

It is noted that the outer diameter of piston stem main portion 78a is smaller than the diameter of poppet chamber 62, and thus a clearance exists therebetween. This clearance forms an annular pushback chamber 80. The lower rim of plunger 82, labelled 83 in FIG. 3 and also referred to as the “pushback surface” hereafter, is exposed to annular pushback chamber 80.

Impact rod 90, extending downwardly below piston driver 72 and towards opening 35, registers with the fastener ejection channel 26.

For further reference, driver chamber 34 is divided in two dynamic, variable volume subchambers: an upper subchamber 34a, and a lower subchamber 34b. Lower subchamber 34b is permanently—i.e. whatever the state of the fastener discharge mechanism 40—in fluid communication with the atmosphere through fastener ejection channel 26, which opens outwardly of the nailer.

Piston assembly 70 is movable within housing 20, between two limit positions. FIG. 3 shows the piston assembly 70 in its standby limit position, where it is moved upwardly, and wherein:
piston stem shoulder 81 abuts against the bottom surface of poppet valve conical end 58;
the free end of impact rod 90 only engages the entrance of fastener ejection channel 26;
piston stem main portion 78a is fully retracted inside poppet chamber 62, and plunger 82 is located adjacent the top end of poppet chamber 62;
orifices 79 at the base of piston stem 78 are sealed by the peripheral wall of piston opening 63 made in poppet conical end 58;
the volume of upper subchamber 34a is at its minimal possible capacity, and the volume of lower subchamber 34b is at its maximal possible capacity.

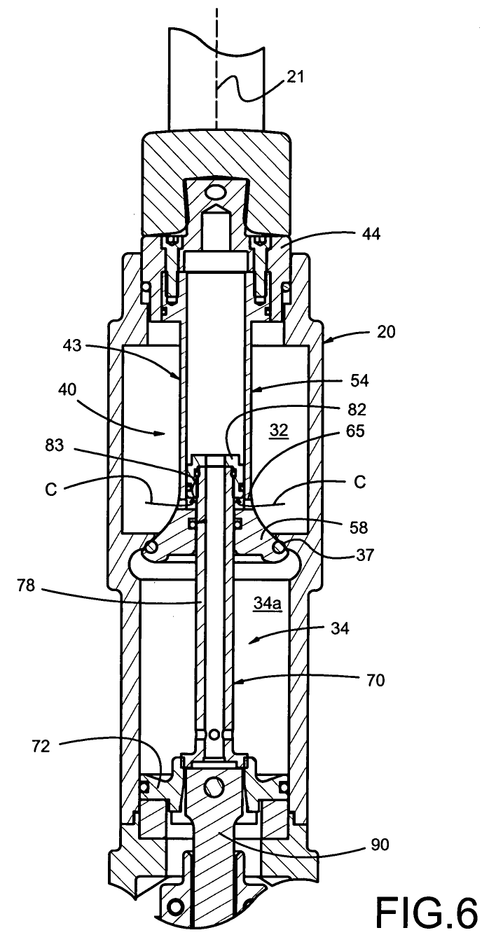

On the other hand, FIG. 6 shows the piston assembly 70 in its extracted position, where it is moved downwardly, and wherein:
the bottom surface of piston driver 72 abuts against the annular shock absorber 41 at the bottom of driver chamber 34;
impact rod 90 engages the entire length of fastener ejection channel 26;
piston stem main portion 78a is fully extracted from poppet chamber 62, and plunger 82 is located next to the bottom end of poppet chamber 62, with its bottom rim 83 remaining just above orifices 65 made in poppet main portion 57, in order to prevent plunger 82 from obstructing these orifices 65;
orifices 79 at the base of piston stem 78 are cleared; piston chamber 84 communicates with upper subchamber 34a therethrough.

The operation of nailer 10 will now be described. Before using nailer 10, it is connected to a compressed air source, e.g. by connecting the outlet hose of an air compressor to air inlet port 31. A strip of fasteners is loaded in magazine 28, and the latter is connected to nailer 10 such that a fastener be loaded in fastener ejection channel 26. The nailer is then positioned above a workpiece (e.g. a tongue and groove hardwood plank), using the nailer's shoe 22 as a guide, as known in the art. Nailer 10 is ready to be triggered.

In its rest position (FIG. 3), reservoir chamber 32 is pressurized and applies a great deal of pressure on return surface 47, which biases trigger member 43 upwardly and keeps it biased towards its rest position. Moreover, in this position as described above, pushback chamber 80 is also pressurized since it communicates with pressurized reservoir chamber 32 through orifices 65 made in poppet valve 54. Pressure is thus applied on plunger rim 83, thus biasing the piston assembly 70 upwardly towards its standby position.

To trigger a nailing cycle, the rubber bumper cap 50 is struck with a heavy tool such as a mallet M (FIG. 1) to urge trigger member 43 downwardly towards its open limit position. The mallet blow on bumper cap 50 and underlying anvil member 44 must be of sufficient intensity to move trigger member 43 downwardly against the upwards biasing force applied on return surface 47 by the compressed air in reservoir chamber 32.

Once bumper cap 43 has been struck and trigger member 43 is moved downwardly (FIG. 4), the poppet valve 54 is also moved downwardly and its conical end 58 clears the bevelled edge 37 of partition opening 36. Fluid communication is thus established between reservoir chamber 32 and upper driver subchamber 34a (above piston driver 72). Upper subchamber 34a thus becomes pressurized (arrow A in FIG. 4).

As the upper subchamber 34a becomes pressurized, a great deal of pressure is applied on the upper surface of piston driver 72. The area of the upper surface of piston driver 72 is much greater than that of annular rim 83 of plunger 82, and thus the overall force applied on piston driver 72 by the compressed air in upper subchamber 34a is of greater intensity than the overall force applied on plunger 82 by the compressed air within pushback chamber 80. Thus, the overall force applied on piston assembly 40 is a downwards one, and the piston assembly 70 is urged downwardly towards its extracted position with great force and velocity. The impact rod 90 sweeps the fastener ejection channel, forcefully strikes the fastener loaded therein and drives it in the subjacent workpiece.

Concomitantly, since the force applied by the mallet is no longer applied on anvil member 44, pressure applied on return surface 47 by the compressed air in reservoir chamber 32 biases trigger member 43 towards its rest position as suggested by arrows B1 and B2 in FIG. 5. Trigger member 43 therefore returns to its rest limit position (as shown in FIG. 6).

The piston assembly 70 thus reaches its extracted limit position, and almost simultaneously, trigger member 43 reaches its rest limit position, as shown in FIG. 6. Fluid communication between reservoir chamber 32 and upper subchamber 34a is now interrupted. At this point, however, upper subchamber 34a is still pressurized.

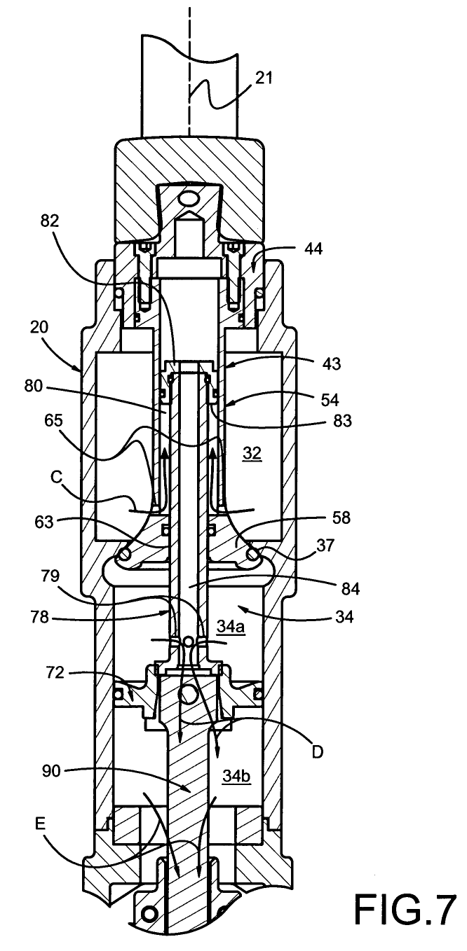

The pressure in upper subchamber 34a having now dropped to atmospheric pressure, the pressure applied from within pushback chamber 80 on plunger annular rim 83 (see arrows C in FIGS. 6-7) therefore biases the piston assembly 70 back to its upper, retracted limit position. Plunger rim 83 thus forms “return means” operating the return of the piston assembly 70 towards its standby position after a nailing stroke.

The compressed air in upper subchamber 34a is exhausted as the piston assembly 70 returns to its standby position (FIG. 7). More particularly, the compressed air in upper subchamber 34a flows into piston chamber 84 through orifices 79, and migrates to lower subchamber 34b by flowing through the gaps 94 shown in FIG. 10 (see arrows D in FIG. 7). The air is then exhausted out of housing 20 by flowing through fastener ejection channel 26 (see arrows E in FIG. 7).

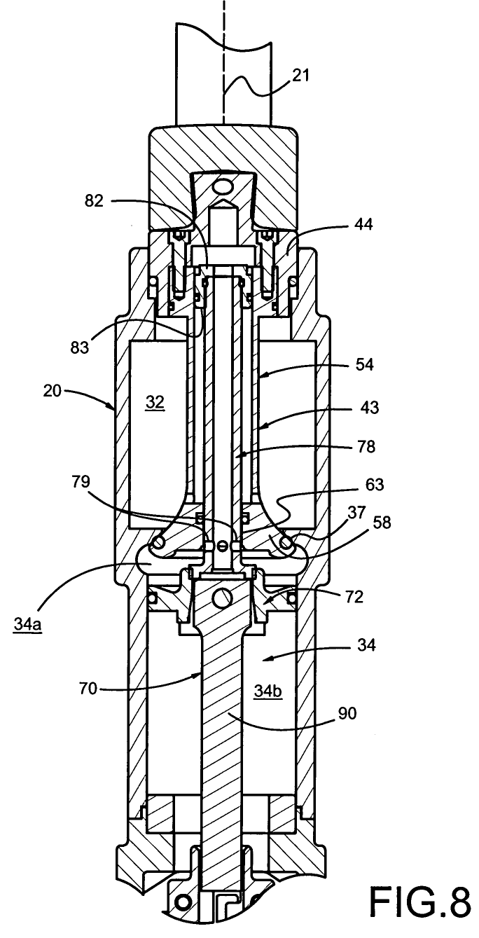

As can be seen in the figures, as piston assembly 70 travels back towards its standby position, orifices 79 on piston stem 78 become obstructed by the peripheral wall of poppet opening 63 before the piston assembly 70 actually reaches its standby limit position, i.e. before piston stem shoulder 81 hits the bottom surface of poppet valve conical end 58. This is shown in FIG. 8. As such, during its return stroke, upper subchamber 34a becomes sealed before the piston assembly 70 actually reaches its standby limit position. Consequently, since piston assembly 70 has acquired a certain momentum while travelling back towards its standby position, air trapped in the thus-sealed upper subchamber 34a acts as an “air cushion” which damps the movement of piston assembly 70 when it nears its return position. In other words, this air cushion slows down piston assembly 70 when it nears its return position, and prevents piston stem shoulder 81 from striking the bottom surface of poppet valve conical end 58 too violently. Accordingly, vibration and noise are limited during operation of pneumatic nailer 10.

It can be readily observed that during the return stroke of the piston assembly 70, upper subchamber 34a is depressurized by flowing sequentially into piston chamber 84 through orifices 79, towards lower subchamber 34b through gaps 94, and out into the atmosphere through the fastener ejection channel 26. This brings about a number of advantages.

With prior art tools, the air in the upper subchamber of the driver chamber is not exhausted through the fastener ejection opening as in the present invention, but rather through holes made in an exhaust cap coupled to the anvil member. Moreover, as the piston assembly of prior art tools moves rapidly back to its rest position, a sudden pressure drop arises in lower subchamber 34b, and as a result ambient air is sucked therein through the fastener ejection channel. Since the assembly of hardwood flooring generally generates a lot of wood dust, a lot of wood dust is sucked into the nailer after each nailing cycle. The inner components of the nailer therefore become gummed up very quickly, and the nailer frequently needs to be opened up, disassembled and cleaned.

On the other hand, the presently claimed invention provides that air be blown out of the nailer—as opposed to air being sucked inside the nailer as in the prior art—as the piston assembly 70 returns to its standby position. Indeed, as the piston assembly moves back to its standby position, the compressed volume of air in the upper subchamber 34a migrates towards the lower subchamber 34b. Since lower subchamber 34b permanently communicates with the atmosphere through the fastener ejection channel 26, the compressed volume of air having migrated therein from plunger upper subchamber 34a will have a tendency to relax by being blown out through the fastener ejection channel 26, until the pressure in lower subchamber 34b drops to atmospheric level.

Therefore, since air is actually blown out of the nailer through fastener ejection channel 26—as opposed to being sucked in the nailer—as the piston assembly returns to its standby position, virtually no dust enters the nailer through fastener ejection channel 26. This significantly reduces the frequency of maintenance and cleaning operations that need to be performed on the nailer.

It is understood that a number of alternate embodiments of the present invention could be envisioned, without departing from the scope of the appended claims.

For example, the fastener discharge mechanism could be substantially different from the one described above. The fastener discharge mechanism could be of any other suitable type as long as it has a piston member comprising at least a piston driver slidably movable in a cylinder, and a striking member (e.g. the impact rod) attached to the piston driver, with the piston member provided with any suitable selectively open exhaust channel.

In the above embodiment, the selectively open exhaust channel is embodied by the openings 79 in piston stem 78, piston chamber 84, and gaps 94, but could have a different configuration. The exhaust channel is selectively opened/closed by clearing/sealing one of its ends (orifices 79). The other end of the exhaust channel opens permanently into lower subchamber 34b. Alternate embodiments of selectively open exhaust channels could be provided on the present invention. Alternately, the exhaust passage could be provided elsewhere than on the piston member; it could for example be routed in the thickness of the driver chamber peripheral wall, with a first end opening in the first subchamber and the second end opening in the second subchamber.

The trigger member could be any other type of selectively activated trigger member, which—when activated—opens a fluid inlet for admitting compressed air in the upper subchamber of the driver chamber, to urge the piston assembly towards the fastener ejection opening of the nailer. Instead of the impact-activated trigger member described above, the trigger member could be a manual button-type trigger located on the handle of the nailer; the nailer would thereby be triggered when the user depresses it with his finger.

The “return means” of the piston member, allowing the piston member to return to its standby position after a nailing stroke, could be different than that described above. The “return means” described above are embodied by the annular rim 83 of the plunger, which is exposed to the pressurized pushback chamber 82. Other suitable return means could be envisioned to allow the automatic return of the piston member towards its standby position after a nailing cycle.

The embodiments of the present invention, in which an exclusive property or privilege is claimed, are defined as follows:

1. A pneumatic nailer for driving nails into a workpiece, said nailer comprising:
a frame defining a fastener ejection opening, and an elongated driver chamber, said driver chamber in turn defining a peripheral wall, a first end away from said fastener ejection opening and a second end towards said fastener ejection opening;
a selectively activated trigger member mounted to said frame;
a piston member movable between a first position and a second position, comprising at least:
a piston driver slidably engaging said driver chamber peripheral wall and movable along said driver chamber, wherein when said piston member is moved towards said first position, said piston driver is moved towards said driver chamber first end, and wherein when said piston member is moved towards said second position, said piston driver is moved towards said driver chamber second end, said piston driver subdividing said driver chamber in two subchambers, namely:
a first subchamber on one side of said piston driver, and comprising a fluid inlet for selectively admitting compressed air in said first subchamber in order to increase the pressure therein and urge said piston driver towards said driver chamber second end;
a second subchamber on another side of said piston driver, said second subchamber for fluid communication with the atmosphere through said fastener ejection channel;
a striking member carried by said piston driver, said striking member engaging said fastener ejection opening at least when said piston member is in said second position;
at least one selectively opened fluid exhaust passage allowing fluid communication between said first subchamber and said second subchamber, said exhaust passage being open at least when said piston member is in said striking position;
wherein when said piston member moves from said second position to said first position, air flows from said first subchamber towards said second subchamber through said exhaust passage, and from said second subchamber outwardly into the atmosphere through said fastener ejection opening.

2. The pneumatic nailer according to claim 1,
wherein said fluid exhaust passage is provided on said piston member.

3. The pneumatic nailer according to claim 2,
further comprising return means capable of moving said piston driver back towards said first position after it has been moved into said second position.

4. The pneumatic nailer according to claim 3,
wherein said return means include a return surface of said piston member, said return surface for exposure to compressed air within said nailer frame, the pressure from compressed air applied on said return surface biasing the piston member towards its said first position.

5. The pneumatic nailer according to claim 3,
wherein said exhaust passage defines a first end and a second end, said exhaust passage second end opening into said second subchamber, and said exhaust passage first end is sealed at least when said piston member is in said first position, and said exhaust passage first end is unsealed and said exhaust passage is open at least when said piston member is in said second position.

6. The pneumatic nailer according to claim 5,
wherein said frame defines a hollow housing, which in turn defines a reservoir chamber and said driver chamber, said reservoir chamber and said driver chamber being separated by a partition having a selectively sealed partition opening therein;
wherein said reservoir chamber is pressurized during operation of said nailer;
wherein when said partition opening is unsealed, said reservoir chamber and said first subchamber fluidly communicate with one another therethrough; and
wherein upon activation of said trigger member, said partition opening is opened and said first subchamber becomes pressurized.

7. The pneumatic nailer according to claim 6,
wherein said trigger member comprises a poppet valve movable within said housing and defining a sealing portion, said poppet valve movable between a closed limit position in which said sealing portion seals said partition opening, and an open position where said sealing portion clears said partition opening.

8. The pneumatic nailer according to claim 7,
wherein said poppet valve is hollow and defines an elongated poppet chamber therein, and said poppet valve has a piston opening in said sealing portion which opens into said poppet chamber, said piston opening defining a peripheral wall;
wherein said piston member further comprises an elongated piston stem attached to and moving as one with said piston driver, said piston stem at least partially penetrating in said poppet chamber through said piston opening, said piston stem sealingly yet slidably engaging said piston opening peripheral wall;
wherein said exhaust passage first end is made in said piston stem; and
wherein at least when said piston member is in said first position, said exhaust passage first end is substantially sealed by said piston opening peripheral wall, and at least when said piston member is in said second position, said exhaust passage first end is cleared by said piston opening peripheral wall.

9. The pneumatic nailer according to claim 8,
wherein said piston stem comprises an elongated main portion slidably engaging said peripheral wall of said poppet valve piston opening, said main portion connected to a piston stem base at one end and carrying a plunger at another end, said piston stem base secured to said piston driver and carrying said striking member, said piston stem base wider than said piston stem main portion; and
wherein an outer peripheral wall of said plunger slidably yet sealingly engages a peripheral wall of said poppet chamber.

10. The pneumatic nailer according to claim 8,
wherein said poppet chamber is elongated and defines a first and a second end,
wherein a pushback chamber is defined in said poppet chamber and is delimited by said piston stem main portion, said poppet chamber peripheral wall, and said plunger, said pushback chamber permanently communicating with said reservoir chamber through at least one orifice made through said poppet chamber peripheral wall;
wherein said plunger defines a pushback surface exposed to said pushback chamber, said pushback surface forming said return means; and
wherein compressed air pressure applied on said plunger pushback surface constantly biases said piston driver towards said first position.

11. The pneumatic nailer according to claim 9,
wherein said exhaust passage first end is located on said piston stem main portion;
wherein said piston member reaches its said first position when said piston stem base strikes a bottom surface of said poppet valve;
wherein said exhaust passage first end becomes sealed by said piston opening peripheral wall before said piston member reaches its said first position, and air trapped in said first subchamber acts as an air cushion to dampen the movement of said piston member towards its said first position.

12. The pneumatic nailer according to claim 6,
wherein said trigger member further comprises an anvil member projecting outwardly of said nailer frame, said anvil member coupled to and moving as one with said poppet valve;
wherein said anvil member can be struck in order to urge said trigger member into its said open position.

13. The pneumatic nailer according to claim 6,
wherein said trigger member further comprises an anvil member projecting outwardly of said nailer frame, said anvil member coupled to and moving as one with said poppet valve;
wherein anvil member can be struck in order to urge said trigger member into its said open position.

14. A pneumatic nailer for driving fasteners under pressurized air bias into a workpiece, said nailer having pressurized air chamber means including a number of subchambers in fluid communication with one another via channel means, said subchambers including an open fastener outlet subchamber, a cyclical fastener discharge means in fluid communication with said air chamber means for forcible release of fasteners one at a time outwardly from said nailer through said fastener outlet subchamber, a trigger member for selectively activating said fastener discharge means for cyclical fastener release one at a time,
wherein said air chamber means includes control means controlling fluid flow through said channel means in such a way as to prevent development of negative air pressure about said fastener outlet subchamber during a full cycle of said cyclical fastener discharge means.

15. The pneumatic nailer according to claim 14,
wherein said cyclical discharge means includes a first fastener discharge step and a second return step where said fastener discharge means returns back to a standby condition activatable by said trigger member,
and wherein said fastener outlet subchamber remains constantly at a positive air pressure during said return step of said fastener discharge means.
